(19) United States
(12) Patent Application Publication
(10) Pub. No.: US 2026/0104505 A1
(43) Pub. Date: Apr. 16, 2026

(54) Antenna for pulse radar

(71) Applicant: COMMISSARIAT A L'ENERGIE ATOMIQUE ET AUX ENERGIES ALTERNATIVES, Paris (FR)

(72) Inventors: Hussein JAAFAR, Grenoble (FR); Serge BORIES, Grenoble (FR); Raffaele D'ERRICO, Grenoble (FR)

(73) Assignee: COMMISSARIAT A L'ENERGIE ATOMIQUE ET AUX ENERGIES ALTERNATIVES, Paris (FR)

(21) Appl. No.: 19/359,027

(22) Filed: Oct. 15, 2025

(30) Foreign Application Priority Data
Oct. 15, 2024 (FR) 24/11175

(51) Int. Cl. G01S 13/88; G01S 7/03; H01Q 1/24; H01Q 9/28; H01Q 23/00

(52) U.S. Cl. CPC G01S 13/885; G01S 7/03; H01Q 1/24; H01Q 9/28; H01Q 23/00

(57) ABSTRACT

An antenna for a pulse radar, the antenna comprising: a functional antenna part including a conductive portion, and a resistive portion, the functional antenna part being capable of occupying a first electrical state in which the resistive portion has a first electrical resistance value, and at least one second electrical state in which the resistive portion has a second electrical resistance value greater than said first electrical resistance value; a control mechanism capable of occupying a first position causing the functional antenna part to occupy the first electrical state, and at least one second position causing the functional antenna part to occupy the at least one second electrical state.

### TECHNICAL FIELD

The present invention, which belongs to the field of ultra-wideband radio equipment, relates in particular to an antenna of a new type usable within a pulse radar system. The present invention also relates to various pulse radar systems comprising at least one antenna according to the invention.

### PREAMBLE

Among ultra-wideband (UWB) systems, we can distinguish ground-penetrating radars (GPR), or radars penetrating into the ground, still commonly referred to as ground radar, which use the principle of the pulse radar systems to probe and image the ground in order to detect the presence of targets buried at different depths such as pipes, natural cavities, tunnels, explosive devices, archaeological elements or even certain minerals.

A pulse radar system comprises an emitting device configured to emit, in particular, electromagnetic radiation towards a target following excitation of the pulse radar system by an electrical signal composed of at least one electrical pulse of very short duration, and a receiving device (sometimes confused with the emitting device in the case of a monostatic radar, as opposed to a bistatic radar which comprises a receiving device distinct from the emitting device) configured to receive, in particular, from said target the response electromagnetic radiation, that is to say the electromagnetic radiation resulting from the reflection on the target of the electromagnetic radiation emitted by the emitting device.

An emitting device of a bistatic ground radar generally comprises at least one emitting antenna, which is coupled to at least one receiving antenna belonging to the receiving device of said bistatic ground radar and generally disposed close to the at least one emitting antenna.

The emitting antenna, suitably excited by an electrical signal composed of a pulse of very short duration, or pulsed signal, emits a radiation in the form of an electromagnetic wave in the direction of the ground in particular, which is successively (1) directly received by the receiving antenna (“cross coupling” or “direct coupling”), (2) reflected on the ground surface then received by the receiving antenna (“front surface echo”) and (3) reflected on a target then received by the receiving antenna (“target echo”).

The composite electromagnetic wave received by the receiving antenna is then converted into an electrical response signal, also known as the impulse response of the ground radar, which successively represents, in the time domain, the direct coupling (or cross coupling) of the antennas, the front surface echo and finally the target echo. After its reception, an analysis of the impulse response is carried out in order to determine, for example, the nature, location or orientation of the target.

In order to ensure an efficient operation of the ground radar, the emitting antenna and the receiving antenna are disposed in close proximity to the ground surface, so that the part of the composite electromagnetic wave corresponding to the front surface echo is generally received by the receiving antenna immediately after the part of the composite electromagnetic wave corresponding to the direct coupling.

Furthermore, the time elapsed between the reception of the part of the composite electromagnetic wave corresponding to the front surface echo and the reception of the part of the composite electromagnetic wave corresponding to the target echo depends on the distance between the target and the pair of emitting and receiving antennas, and is shorter the closer the target is to the antennas.

In the time domain, the part of the impulse response corresponding to the echo from a target located at a shallow depth is therefore very close to the part of the impulse response corresponding to the direct or cross coupling and to the front surface echo, which makes it difficult, or even prevents in certain cases, the detection of such a shallow target since the part of the impulse response corresponding to its echo can go unnoticed, being masked by the part of the impulse response corresponding to the direct coupling and to the front surface echo.

The probability of not noticing the target echo, and therefore of not detecting the latter, is all the greater since the impulse response is also disturbed by unwanted echoes resulting in particular from direct coupling (“time-domain ringing”), which are received immediately after direct coupling of the antennas, or by insignificant echoes from the ground (“radar clutter”), which are for example due to the presence of pebbles in the ground or to a ground with a particularly heterogeneous composition.

It is therefore appropriate to proceed with the elimination, or at least a reduction of said unwanted and/or insignificant echoes (“time-domain clutter reduction” or “time-domain ringing reduction”) in order to allow systematic and efficient detection of shallowly buried targets.

To do this, it is known in particular to integrate electrically resistive elements within the internal structure of the antenna in order to produce an antenna particularly suited to the detection of targets not very shallowly buried in the ground.

However, such an antenna has a lower radiation efficiency, and therefore a reduced ground penetration capability. Thus, such an antenna, suitable for detecting shallowly buried targets, is not suitable for detecting profoundly buried targets, since the electromagnetic wave emitted by such an antenna will probably not reach such targets and/or will not produce a target echo of sufficient intensity to be detectable.

Indeed, an antenna configured to detect targets profoundly buried in the ground must emit a radiation of sufficient intensity to be able to reach the depth necessary for the detection of such targets. Such an antenna must therefore have a high radiation efficiency, and it is therefore not appropriate to integrate resistive elements into its internal structure.

Among the antennas used in the ground radar systems, we therefore distinguish two structurally different types of antennas: the antennas specifically dedicated to the detection of targets located at shallow depths (shallow target detection) and antennas specifically dedicated to the detection of targets located at significant depths (profound target detection).

To be able to effectively probe the ground at different depths, a pulse radar system must therefore theoretically comprise at least one antenna of each of the two aforementioned types, which makes such a system structurally complex and financially expensive due to the number of used antennas, without however guaranteeing high operating efficiency (since only a part of the antennas would be usefully dedicated to each of the two types of profound/shallow detection).

### SUMMARY OF THE INVENTION

The invention aims to remedy all or part of the aforementioned drawbacks.

In particular, the invention relates, according to a first aspect, to an antenna for a radar, the antenna comprising:
a functional antenna part comprising a conductive portion, and a resistive portion having an electrical resistance, the functional antenna part being configured to carrying out:
   a first functional part electrical state in which the resistive portion has a first resistive portion electrical resistance value;
   at least one second functional part electrical state in which the resistive portion has a second resistive portion electrical resistance value greater than said first resistive portion electrical resistance value;
a control mechanism capable of occupying:
   a first control mechanism position causing the functional antenna part to occupy the first functional part electrical state;
   at least one second control mechanism position causing the functional antenna part to occupy the at least one second functional part electrical state.

According to the invention, the antenna comprises a control mechanism configured to switch between the first control mechanism position and the at least one second control mechanism position, which has the effect of switching the functional antenna part between respectively the first functional part electrical state and the at least one second functional part electrical state.

Thus, the control mechanism is configured to switch the functional antenna part from the first functional part electrical state to the at least one second functional part electrical state, and vice versa.

To do this, the control mechanism is configured to switch the resistive portion electrical resistance between the first resistive portion electrical resistance value corresponding to the first functional part electrical state, and the second resistive portion electrical resistance value corresponding to the at least one second functional part electrical state.

More specifically, the control mechanism is configured to change the resistive portion electrical resistance value from the first resistive portion electrical resistance value to the second resistive portion electrical resistance value and vice versa.

According to one possibility, the antenna of the invention is intended to be used within a radar, and for example within a pulse radar.

According to one possibility, the antenna comprises at least one type of antenna among: a Bowtie antenna, a Vivaldi antenna, a Sinuous antenna, a dipole antenna.

By conductive portion is meant a portion that conducts electricity in the operating radio frequency bands, that is to say a portion within which an electrical current can flow, for example an alternating electrical current.

According to one possibility, the conductive portion comprises a metal.

According to one possibility, the functional antenna part comprises a metal. According to this possibility, the functional antenna part is at least partly metallic, and comprises for example a metallic coating on at least a part of a surface of the functional antenna part.

According to one possibility, the resistive portion is at least partly disposed in or on the conductive part.

By first resistive portion electrical resistance value and second resistive portion electrical resistance value, are meant respectively two distinct values which can be taken resistive portion electrical resistance depending on the control mechanism position occupied by the control mechanism.

According to one possibility, the first resistive portion electrical resistance value corresponds to a low electrical resistance, while the second resistive portion electrical resistance value corresponds to a high electrical resistance.

According to one possibility, the first resistive portion electrical resistance value corresponds to a zero, or substantially zero, electrical resistance.

According to one embodiment, the conductive portion comprises a first conductive sub-portion, and a second conductive sub-portion electrically connected to the first conductive sub-portion.

According to this embodiment, said first and second conductive sub-portion are distinct from each other, and an electrical current is configured to flow in both directions between the first conductive sub-portion and the second conductive sub-portion.

For example, at least one electrical cable makes it possible to electrically connect the first conductive sub-portion to the second conductive sub-portion of the functional antenna part.

According to one possibility, the resistive portion is at least partly disposed between the first conductive sub-portion and the second conductive sub-portion, and an electrical current flowing between the first conductive sub-portion and the second conductive sub-portion will for example be caused to pass through at least part of the resistive portion.

According to one possibility, the switching mechanism is at least partly disposed between the first conductive sub-portion and the second conductive sub-portion.

According to one embodiment, the resistive portion comprises a first resistive element and a second resistive element, the control mechanism comprising a first switching element configured to:
occupy a first position of the first switching element in which the first switching element directs towards the first resistive element an electrical current flowing between the first conductive sub-portion and the second conductive sub-portion;
occupy a second position of the first switching element in which the first switching element directs towards the second resistive element said electrical current flowing between the first conductive sub-portion and the second conductive sub-portion.

According to this embodiment, the first switching element is configured to direct, successively and depending on the position it occupies, an electrical current towards the first resistive element or towards the second resistive element.

According to one possibility, the first resistive element is disposed between the first conductive sub-portion and the second conductive sub-portion.

According to one possibility, the second resistive element is also disposed between the first conductive sub-portion and the second conductive sub-portion.

According to one possibility, the first switching element is disposed between the first conductive sub-portion and the second conductive sub-portion.

According to one possibility, the first switching element comprises an SPDT or a single-pole bidirectional switch.

According to one possibility, the first resistive element has an value of the electrical resistance of the first resistive element, and the second resistive element has an value of the electrical resistance of the second resistive element greater than the value of the electrical resistance of the first resistive element.

According to one possibility, the electrical resistance of the first resistive element is comprised between 0 and 50 ohm.

According to one possibility, the value of the electrical resistance of the first resistive element is zero, or substantially zero.

According to one possibility, the electrical resistance of the second resistive element is comprised between 100 and 500 ohm.

According to one possibility, the electrical resistance of the second resistive element is comprised between 300 and 400 ohm, and is for example equal to 370 ohm.

According to one possibility, the electrical current flowing between the first conductive sub-portion and the second conductive sub-portion is an alternating electrical current in the used radio bands, that is to say an electrical current having an electrical intensity which varies over time.

According to one possibility, the resistive portion further comprises a first additional resistive element and a second additional resistive element.

According to one possibility, the first additional resistive element and the second additional resistive element are each disposed between the first conductive sub-portion and the second conductive sub-portion.

According to one possibility, the first additional resistive element is identical to the first resistive element, and/or the second additional resistive element is identical to the second resistive element.

According to one possibility, the control mechanism comprises a first additional switching element configured to occupy a first position of the first additional switching element and a second position of the first additional switching element.

The first additional switching element is arranged to direct an electrical current flowing between the first conductive sub-portion and the second conductive sub-portion respectively towards the first additional resistive element or the second additional resistive element depending on the position occupied by said first additional switching element.

According to one possibility, the first additional switching element is disposed between the first conductive sub-portion and the second conductive sub-portion.

According to one embodiment, the conductive portion comprises a third conductive sub-portion electrically connected to the second conductive sub-portion.

According to this embodiment, the second conductive sub-portion and the third conductive sub-portion are distinct from each other, an electrical current however being configured to flow in both directions between the second conductive sub-portion and the third conductive sub-portion.

According to one possibility, the resistive portion is at least partly disposed between the second conductive sub-portion and the third conductive sub-portion.

According to one embodiment, the resistive portion comprises a third resistive element and a fourth resistive element, the control mechanism comprising a second switching element configured to:
occupy a first position of the second switching element in which the second switching element directs towards the third resistive element an electrical current flowing between the second conductive sub-portion and the third conductive sub-portion;
occupy a second position of the second switching element in which the second switching element directs towards the fourth resistive element said electrical current flowing between the second conductive sub-portion and the third conductive sub-portion.

According to this embodiment, the second switching element is configured to successively direct an electrical current towards the third resistive element or towards the fourth resistive element.

According to one possibility, the second switching element is identical to the first switching element.

According to one possibility, the second switching element comprises an SPDT or a single-pole bidirectional switch.

According to one possibility, the third resistive element is disposed between the second conductive sub-portion and the third conductive sub-portion.

According to one possibility, the fourth resistive element is also disposed between the second conductive sub-portion and the second conductive sub-portion.

According to one possibility, the third resistive element has a value of the electrical resistance of the third resistive element, and the fourth resistive element has a value of the electrical resistance of the fourth resistive element greater than the value of the electrical resistance of the third resistive element.

According to one possibility, the electrical resistance of third resistive element is comprised between 0 and 50 ohm.

According to one possibility, the value of the electrical resistance of the third resistive element is zero, or substantially zero.

According to one possibility, the electrical resistance of the fourth resistive element is comprised between 100 and 500 ohm.

According to one possibility, the electrical resistance of the fourth resistive element is comprised between 100 and 200 ohm, and is for example equal to 160 ohm.

According to one possibility, the electrical current flowing between the third conductive sub-portion and the fourth conductive sub-portion is an alternating electrical current, that is to say an electrical current having an electrical intensity which varies over time.

According to one possibility, the resistive portion further comprises a third additional resistive element and a fourth additional resistive element.

According to one possibility, the third additional resistive element and the fourth additional resistive element are each disposed between the second conductive sub-portion and the third conductive sub-portion.

According to one possibility, the third additional resistive element is identical to the third resistive element, and/or the fourth additional resistive element is identical to the fourth resistive element.

According to one possibility, the control mechanism comprises a second additional switching element configured to occupy a first position of the second additional switching element and a second position of the second additional switching element.

The second additional switching element is arranged to direct an electrical current flowing between the second conductive sub-portion and the third conductive sub-portion respectively towards the third additional resistive element or the fourth additional resistive element depending on the position occupied by said second additional switching element.

According to one possibility, the second additional switching element is disposed between the second conductive sub-portion and the third conductive sub-portion.

According to one possibility, the conductive portion further comprises a fourth conductive sub-portion electrically connected to the third conductive sub-portion, and the resistive portion comprises a fifth resistive element and a sixth resistive element, and the control mechanism comprises a third switching element configured to direct an electrical current flowing between the third conductive sub-portion and the fourth conductive sub-portion towards the fifth resistive element or the sixth resistive element depending on the position it occupies.

According to one embodiment, the antenna comprises an antenna excitation part configured to transmit
an electrical current to the functional antenna part.

The excitation part is configured to excite the functional antenna part, that is to say to transmit an adequate electrical current to it so that the functional antenna part produces an electromagnetic radiation corresponding to the electrical current transmitted to it by the excitation part.

According to one possibility, the antenna comprises an antenna excitation part configured to transmit to the functional antenna part an electrical current, such as for example an alternating electrical current, which is then intended in particular to flow through the conductive portion of the functional antenna part.

According to one possibility, the antenna excitation part is configured to transmit to the functional antenna part an alternating electrical current composed of a pulse of very short duration.

According to one possibility, the antenna comprises an additional functional antenna part.

According to this possibility, the antenna excitation part is also configured to transmit to the additional functional antenna part an alternating electrical current, and for example an alternating electrical current composed of a pulse of very short duration.

According to one possibility, the additional functional antenna part is identical to the functional antenna part, and therefore has the same structure and in particular a conductive portion identical to the conductive portion of the functional antenna part and a resistive portion identical to the resistive portion of the functional antenna part.

According to one possibility, the functional part and the additional functional antenna part are respectively disposed on either side of the antenna excitation part.

According to one embodiment, when the antenna excitation portion transmits an electrical current to the functional antenna part, the conductive portion is traversed by an electrical current and the functional antenna part is configured to emit an electromagnetic radiation.

According to this embodiment, the antenna can operate as an emitting antenna, and the functional antenna part comprises a radiating element which, suitably excited by an electrical current, is configured to emit an electromagnetic radiation in at least one direction.

Once transmitted to the functional antenna part, the electrical current flows through the conductive portion of the functional antenna part, which gives rise to the emission of an electromagnetic wave.

According to the invention, the electrical intensity of the electrical current flowing through the conductive portion of the functional antenna part is attenuated by the resistive portion, and in particular more or less attenuated by the resistive portion electrical resistance value.

Indeed, when, for example, the conductive portion comprises a first conductive sub-portion and a second conductive sub-portion electrically connected to the first conductive sub-portion, the electrical current transmitted by the antenna excitation part first propagates on the first conductive sub-portion, then reaches the second conductive sub-portion by passing through the first resistive element or the second resistive element depending on the position occupied by the first switching element.

When the antenna is operating as an emitting antenna, the functional antenna part may alternately occupy the first functional part electrical state, or the at least one second functional part electrical state.

Thus, depending on the needs or applications, the control mechanism can therefore occupy the first control mechanism position for a lower resistive portion electrical resistance, or the at least one second control mechanism position for a higher resistive portion electrical resistance and therefore a greater attenuation of the electrical current flowing through the conductive portion.

According to one embodiment, the functional antenna part is configured to capture an incident electromagnetic radiation and to convert said incident electromagnetic radiation into an electrical current flowing through the conductive portion.

According to this embodiment, the antenna can operate as a receiving antenna, and the functional antenna part is configured to detect and capture an incident electromagnetic radiation, that is to say an electromagnetic radiation propagating around the antenna, said incident electromagnetic radiation then being converted into an electrical current in particular intended to flow through the conductive portion of the functional antenna part.

Thus, an antenna according to the invention can operate as an emitting antenna, for which the functional antenna part emits an electromagnetic radiation, and/or as a receiving antenna, for which the functional antenna part captures an incident electromagnetic radiation.

According to a second aspect, the invention relates to a radar comprising at least one antenna as defined above, the radar being configured to operate in:
a first radar operating mode in which the functional antenna part occupies the first functional part electrical state;
at least one second radar operating mode in which the functional antenna part occupies the at least one second functional part electrical state.

According to one possibility, the radar of the invention comprises a pulse radar.

According to one possibility, the radar of the invention can be used in all fields involving non-destructive search and detection.

According to one possibility, the radar of the invention can be used in the medical field, for example for the detection of tumors.

According to one possibility, the radar of the invention comprises a ground penetrating radar or ground radar.

According to the latter possibility, the first radar operating mode corresponds to a profound detection mode in which the radar is particularly suited to detecting profoundly buried targets, and the second radar operating mode corresponds to a shallow detection mode in which the radar is particularly suited to detecting targets close to the ground surface.

According to one possibility, the at least one antenna is disposed within a cavity, for example a cavity delimited by a parallelepiped-shaped metal box comprising at least one opening.

According to one possibility, the metal box has a parallelepiped shape, and is open on one of its six sides.

According to one possibility, at least one external resistive element is disposed between the at least one antenna and a wall of the metal box.

For example, the at least one external resistive element is disposed between a surface of the functional antenna part and a wall of the metal box.

In particular, the at least one external resistive element is disposed between a surface of the conductive portion and a wall of the metal box.

According to one possibility, the at least one external resistive element has an electrical resistance of value comprised between 50 and 500 ohm, and for example equal to 100 ohm or equal to 400 ohm.

According to one embodiment, the radar comprises at least one first antenna and one second antenna as defined above, the radar being a ground radar.

According to this configuration mode, the first antenna is intended to occupy an emitting antenna function, and the second antenna is intended to occupy a receiving antenna function.

According to one possibility, the ground radar of the invention comprises at least two antennas intended to function as emitting antennas, and at least two antennas intended to function as receiving antennas.

According to one possibility, the ground radar of the invention comprises at least six antennas intended to function as emitting antennas, for example eight emitting antennas, and at least six antennas intended to function as receiving antennas, for example eight receiving antennas.

According to one possibility, the eight emitting antennas and the eight receiving antennas are all comprised within a cavity delimited by a parallelepiped-shaped housing having an open side facing the ground towards which the electromagnetic radiation emitted by the eight emitting antennas is directed.

According to one possibility, the radar comprises a conversion part configured to convert the electrical current from the incident electromagnetic radiation captured by the receiving antenna(s) into a time signal representative of a radar impulse response.

According to a third aspect, the invention relates to a method for operating a radar as defined above, the method comprising:
a step of switching the control mechanism of the at least one first antenna to the first control mechanism position or to the at least one second control mechanism position;
a step, implemented by the antenna excitation part of the at least one first antenna, of exciting the functional antenna part of the at least one first antenna;
a step, implemented by the functional antenna part of the at least one first antenna, of emitting an electromagnetic radiation;
a step, implemented by the functional antenna part of the at least one second antenna, of detecting an incident electromagnetic radiation.

According to one possibility, the radar comprises a plurality of first antennas, the switching step comprising a step of switching the control mechanism of each of the plurality of first antennas.

According to one possibility, the radar comprises a plurality of second antennas, the detection step comprising a step, implemented by the functional antenna part of each of the second antennas of the plurality of second antennas, of detecting an incident electromagnetic radiation.

According to one possibility, the method comprises a step of determining a desired radar operating mode among the first radar operating mode and the at least one second radar operating mode.

According to one possibility, the switching step is a function of the result of the determination step.

Especially, the control mechanism of the first antenna switches to the first control mechanism position if the first radar operating mode is determined in the determination step or to the at least one second control mechanism position if the at least one second radar operating mode is determined in the determination step.

According to one possibility, the method comprises a step of generating an alternating electrical current comprising at least one pulse.

For example, this generation step may comprise a step of sequentially emitting several narrowband signals so as to synthesize a pulse.

According to one possibility, the excitation step comprises a step of transmitting to the functional antenna part of the first antenna, implemented by the antenna excitation part of the first antenna, the alternating electrical current generated in the generation step.

According to one possibility, the method comprises a step of propagating the alternating electrical current generated in the generation step on the conductive portion of the functional antenna part of the first antenna.

According to one possibility, the electromagnetic radiation emitted at the emission step is directed downwards, in particular towards a ground, along a vertical direction substantially perpendicular to the surface of the flat ground.

According to one possibility, the electromagnetic radiation emitted at the emission step is at least partly reflected by a target buried in the ground.

According to one possibility, the electromagnetic radiation emitted at the emission step is at least partly reflected by the surface of the ground towards which it is directed.

According to one possibility, the incident electromagnetic radiation captured by the second antenna comprises a component corresponding to the reflection on the target of the electromagnetic radiation emitted by the first antenna, a component corresponding to the reflection on the ground surface of the electromagnetic radiation emitted by the first antenna, and a component corresponding to the part of the electromagnetic radiation emitted by the first antenna received directly.

According to one possibility, the method comprises a step of converting the incident electromagnetic radiation into an electrical current configured to flow through the conductive portion of the functional antenna part of the second antenna.

According to one possibility, the method also comprises a step of converting the electrical current induced by the incident electromagnetic radiation into a radar impulse response.

According to one possibility, the method comprises a step of analyzing said radar impulse response in order to determine at least one piece of information on the target, such as a position of the target, an orientation of the target, a nature of the target, a dimension of the target.

The antenna of the invention is reconfigurable, that is to say that its functional antenna part is configured to occupy at least two distinct electrical states having an influence on the features of the emitted electromagnetic radiation, which makes it possible, when the antenna is used within a radar system, to be able to work according to two distinct radar operating modes: a first mode favoring the detection of objects not very shallowly buried in the ground, and a second mode favoring the detection of objects located at significant depths.

The ground radar of the invention is therefore capable of detecting not only shallow targets, but also targets profoundly buried in the ground, and is therefore useful for effectively probing and imaging the ground at different depths.

### BRIEF DESCRIPTION OF THE FIGURES

The invention will be better understood, and its principles and advantages will become more apparent, upon reading the detailed description below, made with reference to the following figures:

FIG. 1a and FIG. 1b schematically illustrate the operating principles of a bistatic ground radar.

FIG. 2a is a schematic representation of an antenna according to one embodiment of the invention.

FIG. 2b and FIG. 2c illustrate the operating principles of electrical circuits belonging to the antenna of FIG. 2a.

FIG. 2d is a schematic representation of the antenna of FIG. 2a in a first electrical state.

FIG. 2e is a schematic representation of the antenna of FIG. 2a in a second

electrical state.

FIG. 3a represents an impulse response of a ground radar comprising an emitting antenna according to FIG. 2a occupying the electrical state of FIG. 2d, said impulse response corresponding to the detection of a profoundly buried target.

FIG. 3b represents an impulse response of a ground radar comprising an emitting antenna according to FIG. 2a occupying the electrical state of FIG. 2e, said impulse response corresponding to the detection of a shallowly buried target.

FIG. 4 represents a radar comprising eight antennas conforming to that of FIG. 2a occupying the function of emitting antenna, and eight antennas conforming to that of FIG. 2a occupying the function of receiving antenna.

FIG. 5a and FIG. 5b represent respectively a top view and a side view of the radar of FIG. 4 in operating situation.

FIG. 6a represents a first radar diagram obtained when the radar of FIG. 4 operates according to the first radar operating mode.

FIG. 6b represents a second radar diagram obtained when the radar of FIG. 4 operates according to the second radar operating mode.

FIG. 7 represents a first receiving antenna impulse response obtained in the first radar operating mode, and a second receiving antenna impulse response obtained in the second radar operating mode.

### DETAILED DESCRIPTION

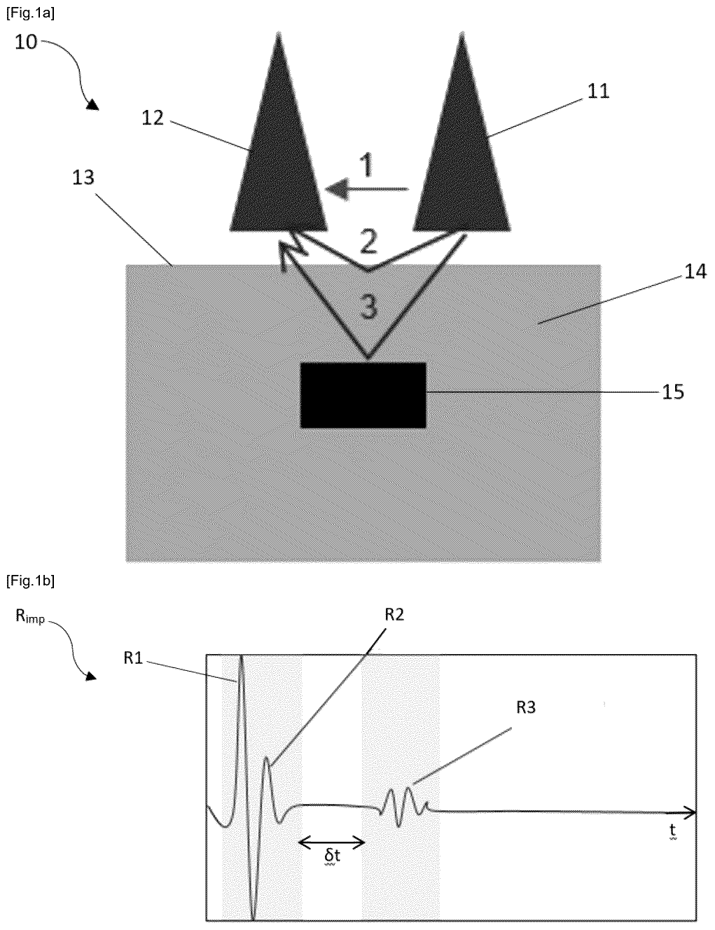

The ground radar 10 of FIG. 1a comprises an emitting antenna 11 and a receiving antenna 12 located close to each other, each of said antennas also being located close to a surface 13 of a ground 14 within which a target 15 is buried, for example a metal box.

The emitting antenna 11 emits an electromagnetic radiation. The ground radar 10 is in particular a pulse radar in which the emitting antenna 11 emits an electromagnetic radiation when it is excited by an alternating electrical current composed of at least one pulse of very short duration and which propagates on a conductive part of the emitting antenna 11.

A first part 1 of said electromagnetic radiation is directly (direct coupling) received by the receiving antenna 12, a second part 2 of said electromagnetic radiation is reflected by the surface 13 of the ground 14 and then received by the receiving antenna 12, and a third part 3 of said electromagnetic radiation penetrates the ground 14, is reflected by the target 15 and then received by the receiving antenna 12.

The capture of the incident electromagnetic radiation by the receiving antenna 12 generates an alternating electrical current which propagates on a conductive part of the receiving antenna 12, the electrical intensity of the alternating electrical current being represented as a function of time by means of the time signal of FIG. 1b representing the impulse response Rᵢₘₚ.

The incident electromagnetic radiation captured by the receiving antenna therefore gives rise to the impulse response Rᵢₘₚ represented in FIG. 1b and which therefore comprises a first component R1 corresponding to the direct coupling of the two antennas, a second component R2 corresponding to the reflection on the ground surface of the electromagnetic radiation emitted by the emitting antenna, and a third component R3 corresponding to the reflection on the target of the electromagnetic radiation emitted by the emitting antenna.

The component R3 of the impulse response Rᵢₘₚ has an electrical intensity much lower than the electrical intensity of the component R1, and to a lesser extent than the electrical intensity of the component R2.

Furthermore, the component R1 and the component R2 of the impulse response Rᵢₘₚ are located close to each other, which means that the second part 2 of the electromagnetic radiation reflected by the surface 13 of the ground 14 is received by the receiving antenna 12 very shortly after the first part 1 of the electromagnetic radiation received directly by the receiving antenna 12.

The third component R3 of the impulse response Rᵢₘₚ is separated from the components of the component R2 by a time interval δt corresponding to the duration between the reception of the second part 2 of the electromagnetic signal reflected by the surface 13 of the ground 14 and the reception of the third part 3 of the electromagnetic radiation reflected by the target 15.

This time interval δt depends directly on the distance between the target 15 and the emitting antennas 11 and 12 respectively, and it is obvious that the less the target 15 is far from either of these emitting antennas 11 and 12, the less the time interval δt will be.

Thus, a component of an impulse response Rᵢₘₚ of a radar corresponding to the reflection of an electromagnetic radiation emitted on a shallowly buried target can go unnoticed, being confused with the component corresponding to the front surface echo or even with an unwanted echo.

In addition, spurious signals or unwanted echoes corresponding to “time-domain ringing” or “radar clutter” phenomena also disrupt the impulse response Rᵢₘₚ and potentially make it difficult to identify the component corresponding to the target echo.

However, if the component corresponding to the target echo goes unnoticed, the target in question will obviously neither be detected nor subsequently analyzed by the ground radar.

To limit the effect of spurious signals and unwanted echoes in the impulse response and therefore their influence on the detection of the target echo, it is possible to integrate resistive loads, or resistive elements, within the emitting antenna itself.

The integration of such resistive loads into the very structure of the antenna nevertheless has the disadvantage of reducing the radiation efficiency of the antenna and therefore its capability to detect targets buried more profoundly in the ground.

In order to be able to detect such “profound” targets, the emitting antenna must in fact have a high radiation efficiency, in order to emit an electromagnetic radiation of sufficient intensity to be able to reach said target, and to produce a target echo of sufficient intensity to be able to be detected by the receiving antenna.

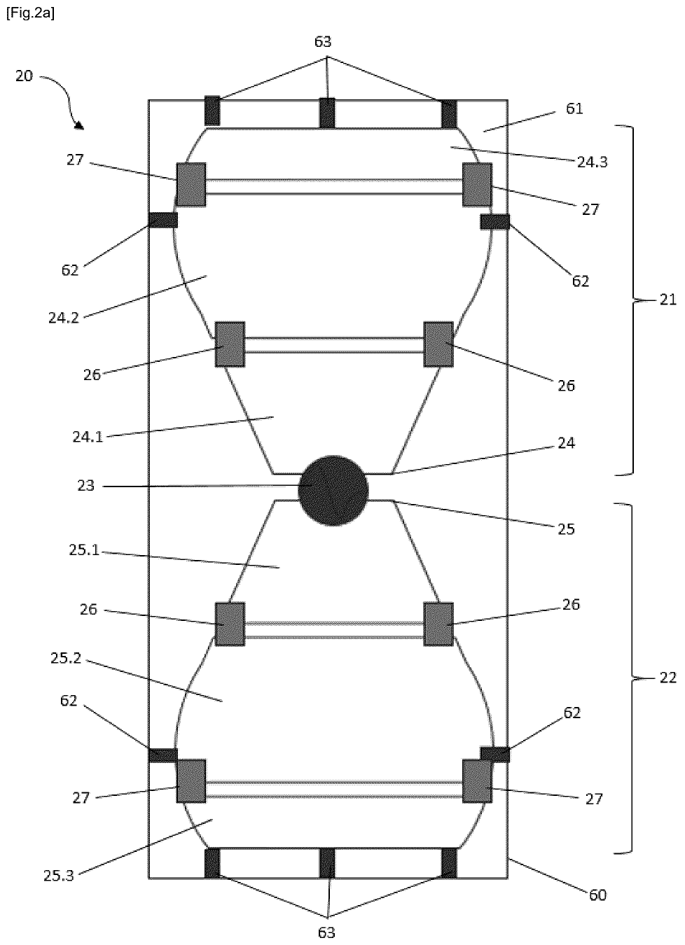

The present invention aims to resolve these drawbacks thanks in particular to the antenna 20 shown in FIG. 2a, which corresponds to a particular and non-limiting embodiment of the invention.

The antenna 20 is a Bowtie-type antenna or butterfly antenna (“Bowtie antenna”) represented as being disposed within a cavity 61 delimited by a box 60 of parallelepiped shape comprising metal walls and at least one opening (not shown) allowing the antenna 20 to be able to emit an electromagnetic radiation outwards in at least one direction.

The antenna 20 comprises a first functional antenna part 21 which may for example be a metal plate, and a second functional antenna part 22 identical to the first functional antenna part 21.

The antenna also comprises an excitation part 23 configured to excite respectively the first functional antenna part 21 and the second functional antenna part 22, that is to say to transmit an alternating electrical current, for example composed of pulses, to respectively the first functional antenna part 21 and the second functional antenna part 22.

In addition, the first functional antenna part 21 and the second functional antenna part 22 are respectively disposed on either side of the excitation part 23.

The first functional antenna part 21 comprises a conductive portion 24 composed of a first conductive sub-portion 24.1, a second conductive sub-portion 24.2 electrically connected to the first conductive sub-portion 24.1 through two first electrical circuits 26, and a third conductive sub-portion 24.3 electrically connected to the second conductive sub-portion 24.2 through two second electrical circuits 27.

Similarly, the second functional antenna part 22 comprises a conductive portion 25 composed of a first conductive sub-portion 25.1, a second conductive sub-portion 25.2 electrically connected to the first conductive sub-portion 25.1 through two first electrical circuits 26, and a third conductive sub-portion 25.3 electrically connected to the second conductive sub-portion 25.2 through two second electrical circuits 27.

Resistive loads are further disposed between the antenna 20 and the walls of the box 60.

In particular, two first external resistive loads 62 are disposed between the second conductive sub-portion 24.2 of the first functional antenna part 21 and respectively two walls of the box 60, and three second external resistive loads 63 are disposed between the third conductive sub-portion 24.3 of the first functional antenna part 21 and a wall of the box 60.

Similarly, two first external resistive loads 62 are disposed between the second conductive sub-portion 25.2 of the second functional antenna part 22 and respectively two walls of the box 60, and three second external resistive loads 63 are disposed between the third conductive sub-portion 25.3 of the second functional part 22 and a wall of the box 60.

In the shown embodiment, said first external resistive loads 62 each have an electrical resistance equal to 100 ohm, while said second external resistive loads 63 each have an electrical resistance equal to 400 ohm. Obviously, other electrical resistance values are conceivable.

The principles of operation of said first electrical circuits 26 and second electrical circuits 27 are respectively illustrated in FIG. 2b and FIG. 2c.

It is to be noted that the structure and operation of the first electrical circuits 26 are similar to the structure and operation of the second electrical circuits 27.

In particular, each first electrical circuit 26 and each first electrical circuit 27 comprises a switching element 28 of the SPDT switch type or single-pole bidirectional switch type (“SPDT switch” or “Single Pole Double Throw switch”).

The switching element 28, which comprises one input and two outputs, makes it possible to direct, depending on the position it occupies, an electrical current received at its input towards one or the other of its two outputs, which are respectively connected to resistive elements (or resistive loads) having distinct electrical resistance values. More precisely, the switching element 28 is configured to occupy a first position 28.1 or a second position 28.2 of the switching element.

Within the first functional antenna part 21, the switching element 28 belonging to the first electrical circuits 26 receives at its input the electrical current flowing between the first conductive sub-portion 24.1 and the second conductive sub-portion 24.2, and the switching element 28 belonging to the second electrical circuits 27 receives at its input the electrical current flowing between the second conductive sub-portion 24.2 and the third conductive sub-portion 24.3.

Similarly, within the second functional antenna part 22, the switching element 28 belonging to the first electrical circuits 26 receives at its input the electrical current flowing between the first conductive sub-portion 25.1 and the second conductive sub-portion 25.2, and the switching element 28 belonging to the second electrical circuits 27 receives at its input the electrical current flowing between the second conductive sub-portion 25.2 and the third conductive sub-portion 25.3.

In position 28.1, the switching element 28 belonging to the first electrical circuits 26 directs the electrical current received at its input towards a resistive element 31 having an electrical resistance substantially equal to 0 ohm, while in position 28.2, the switching element 28 belonging to the first electrical circuits 26 directs the electrical current received at its input towards a resistive element 32 having an electrical resistance equal to 370 ohm.

In position 28.1, the switching element 28 belonging to the second electrical circuits 27 directs the electrical current received at its input towards a resistive element 33 having an electrical resistance substantially equal to 0 ohm, while in position 28.2, the switching element 28 belonging to the second electrical circuits 27 directs the electrical current received at its input towards a resistive element 34 having an electrical resistance equal to 160 ohm.

Thus, the antenna 20 comprises a control mechanism consisting of the different switching elements 28, and a resistive portion consisting of the different resistive elements 31, 32, 33, 34.

The control mechanism of the antenna 20 is configured to be able to occupy a first control mechanism position in which all the switching elements 28 belonging to the first electrical circuits 26 occupy the first position 28.1 and in which all the switching elements 28 belonging to the second electrical circuits 27 also occupy the first position 28.1.

The control mechanism of the antenna 20 is also configured to be able to occupy a second control mechanism position in which all the switching elements 28 belonging to the first electrical circuits 26 occupy the second position 28.2 and in which all the switching elements 28 belonging to the second electrical circuits 27 also occupy the second position 28.2.

The first control mechanism position causes the first and second functional antenna parts 21, 22 to occupy a first functional part electrical state (shown in FIG. 2d), while the second control mechanism position causes the first and second functional antenna parts 21, 22 to occupy a second electrical state (shown in FIG. 2e).

In the second functional part electrical state, the resistive portion, consisting in particular of the resistive elements 32 and 34 (FIG. 2e), has an electrical resistance value greater than the electrical resistance value presented by the resistive portion in the first state of the functional part in which the resistive portion consists of the resistive elements 31 and 33 (FIG. 2d).

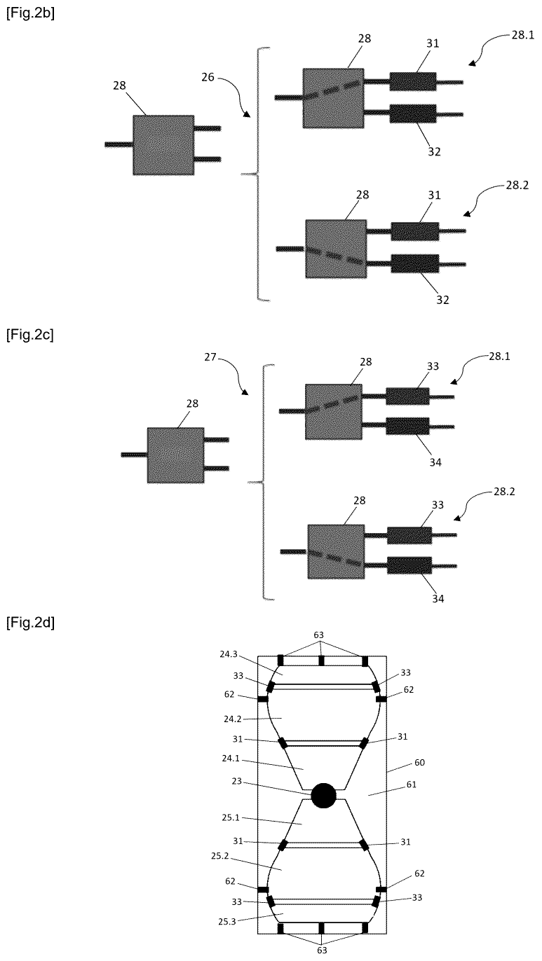

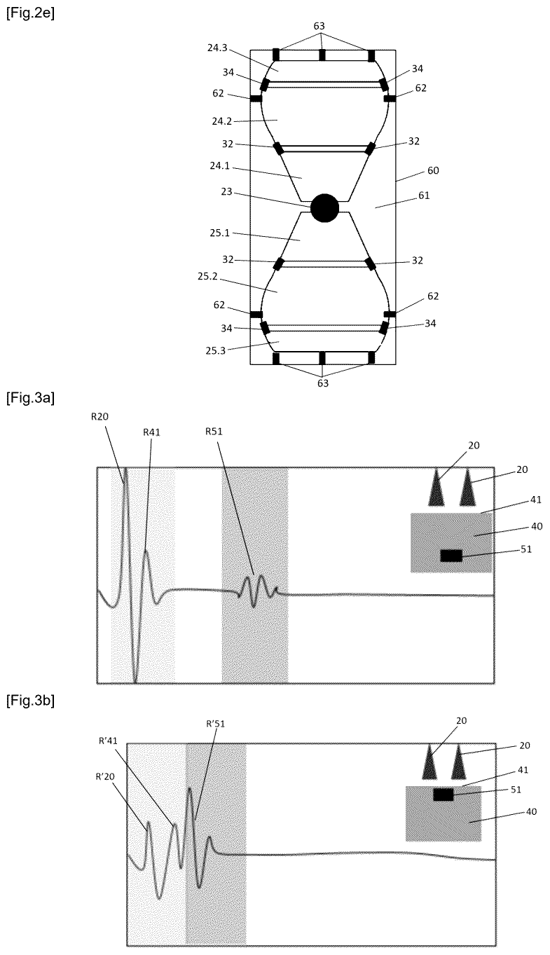

As shown in FIGS. 3a and 3b, the antenna 20 can be integrated within a bistatic ground radar comprising at least one first antenna 20 occupying the function of emitting antenna and a second antenna 20 occupying the function of receiving antenna.

When the first and second functional antenna parts of the antenna 20 acting as an emitting antenna occupy the first functional part electrical state, the ground radar is particularly suitable for detecting a target 51 profoundly buried in a ground 40, that is to say a target 51 distant from a surface 41 of the ground 40, as shown in FIG. 3a.

In this electrical state, the radiation efficiency of the first and second functional antenna parts 21, 22 is high, since the resistive portion, which has substantially zero electrical resistance, does not attenuate or only slightly attenuates the alternating electrical current which flows through the conductive portions 24, 25 following the excitation exerted by the antenna excitation part 23.

The component R20 of the impulse response corresponding to the direct coupling of the emitting and receiving antennas 20, and the component R41 corresponding to the echo from the surface 41 of the ground 40 therefore have high intensities.

However, the component R51 corresponding to the echo from the target 51 being received well after and having sufficient intensity, is clearly identified.

When the first and second functional antenna parts of the antenna 20 acting as an emitting antenna occupy the second functional part electrical state, the ground radar is particularly suitable for detecting the target 51 shallowly buried in the ground 40, that is to say the target 51 is located close to the surface 41 of the ground 40, as shown in FIG. 3b.

In this electrical state, the radiation efficiency of the first and second functional antenna parts 21, 22 is lower, since the resistive portion, which has a higher electrical resistance, attenuates the alternating electrical current which flows through the conductive portions 24, 25 following the excitation exerted by the antenna excitation part 23, which also makes it possible to attenuate the intensity of the emitted electromagnetic radiation.

The component R′20 of the impulse response corresponding to the direct coupling of the emitting and receiving antennas 20, and the component R′41 corresponding to the echo from the surface 41 of the ground 40 therefore have lower intensities. In addition, the unwanted echoes (“time-domain ringing”) resulting in particular from the direct coupling are also attenuated.

The component R′51 corresponding to the echo from the target 51, although received immediately after the ground surface echo R′41, is clearly distinguishable and is therefore identified.

The interest and the effectiveness of the reconfigurable antenna of the invention have been more concretely highlighted by a field experiment carried out by the inventors and implementing a ground radar 70 comprising a first group 71 of eight emitting antennas 20 20ₜ₁-20ₜ₈ disposed within a first compartmentalized metal box, and a second group 72 of eight receiving antennas 20 20ᵣ₁-20ᵣ₈ also disposed within a second compartmentalized metal box identical to the first compartmentalized metal box.

The first metal box and the second metal box each comprise eight compartments each receiving an antenna, each compartment comprising at least one opening allowing each emitting antenna 20ₜ₁-20ₜ₈ to emit an electromagnetic radiation outwards in at least one direction, and allowing each receiving antenna 20ᵣ₁-20ᵣ₈ to receive and capture an incident electromagnetic radiation.

Such a ground radar 70 can be used to effectively detect and identify in turn a first target shallowly buried, and a second target profoundly buried in a ground.

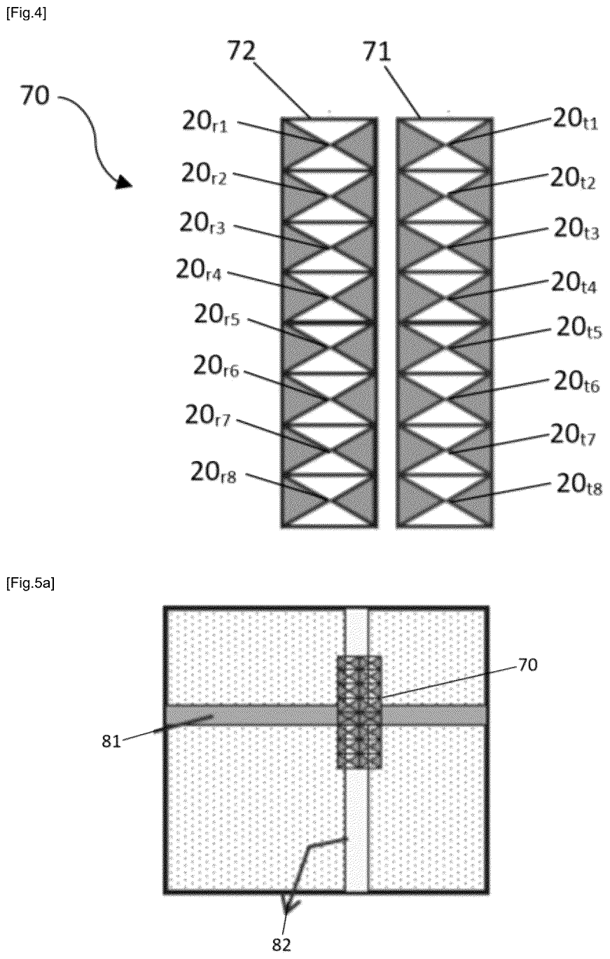

To do this and as shown in FIGS. 5a and 5b, the first metal box comprising the first group 71 of the eight emitting antennas 20ₜ₁-20ₜ₈ and the second metal box comprising the second group 72 of the eight receiving antennas 20ᵣ₁-20ᵣ₈ are disposed side by side approximately 30 millimeters (mm) from a surface 76 of a sandy soil 75 covering a metal plate and within which are buried respectively a first hollow pipe 81 comprising a PVC wall and a second pipe 82 also hollow and comprising a PVC wall.

Such an arrangement of the first group 71 of the eight emitting antennas 20ₜ₁-20ₜ₈ and of the second group 72 of the eight receiving antennas 20ᵣ₁-20ᵣ₈ allows said antennas to operate mainly in pairs of antennas, that is to say that the incident electromagnetic radiation captured by the receiving antenna 20rx corresponds mainly to the electromagnetic radiation emitted by the emitting antenna 20rx of the same index x (x=1 to 8).

The first pipe 81, located about 200 mm from the surface 76 of the ground 75, acts as a profoundly buried target, while the second pipe 82, located about 700 mm from the surface 76 of the ground 75, acts as a shallowly buried target.

The radar 70 is capable of operating in a first radar operating mode in which the control mechanism of the emitting antennas 20ₜ₁-20ₜ₈ occupies the first control mechanism position, or in a second radar operating mode in which the control mechanism of the emitting antennas 20ₜ₁-20ₜ₈ occupies the second control mechanism position.

In order for the radar 70 to operate in the first radar operating mode, the control mechanism of each emitting antenna 20ₜ₁-20ₜ₈ is switched to the first control mechanism position in which each switching element 28 occupies the first position 28.1 of the switching element.

In this first radar operating mode, the functional antenna parts 21, 22 of the emitting antennas 20ₜ₁-20ₜ₈ therefore occupy the first functional part electrical state in which the resistive portions have a substantially zero electrical resistance.

The antenna excitation part 23 of each emitting antenna 20ₜ₁-20ₜ₈ transmits a pulsed alternating electrical current to the functional antenna parts 21, 22 of each emitting antenna 20ₜ₁-20ₜ₈.

Following this excitation, the functional antenna parts 21, 22 of each emitting antenna 20ₜ₁-20ₜ₈ emit an electromagnetic radiation in particular directed towards the surface 76 of the ground 75.

The functional antenna parts 21, 22 of each receiving antenna 20ᵣ₁-20ₜ₈ capture an incident electromagnetic radiation corresponding to the electromagnetic radiation emitted by each emitting antenna 20ₜ₁-20ₜ₈.

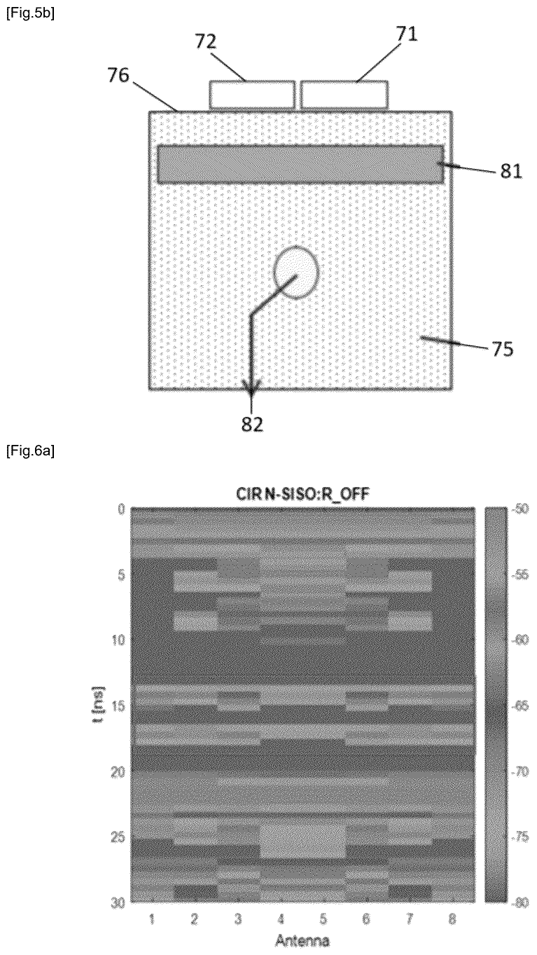

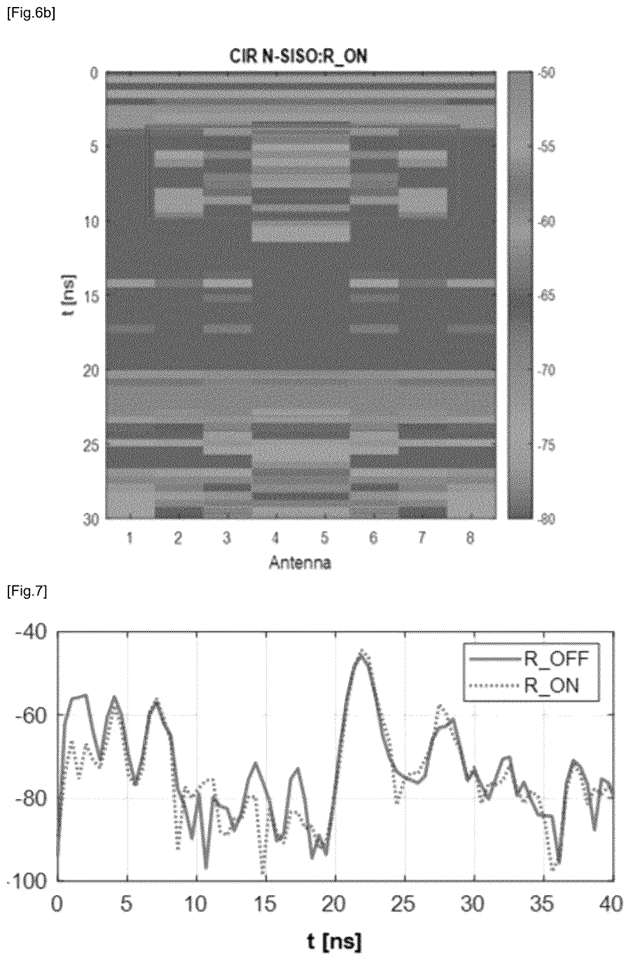

A first radar diagram (shown in FIG. 6a) is then obtained, as well as a first impulse response of each of the receiving antennas 20ᵣ₁-20ᵣ₈. In particular, the impulse response of the receiving antenna 20ᵣ₄ is shown in solid lines in FIG. 7.

In order for the radar 70 to operate in the second radar operating mode, the control mechanism of each emitting antenna 20ₜ₁-20ₜ₈ is switched to the second control mechanism position in which each switching element 28 occupies the second position 28.2 of the switching element.

In this second radar operating mode, the functional antenna parts 21, 22 of the emitting antennas 20ₜ₁-20ₜ₈ therefore occupy the second functional part electrical state in which the resistive portions have a high electrical resistance making it possible to attenuate the alternating electrical current flowing through the conductive portions 24, 25 of the emitting antennas 20ₜ₁-20ₜ₈.

The antenna excitation part 23 of each emitting antenna 20ₜ₁-20ₜ₈ again transmits a pulsed alternating electrical current to the functional antenna parts 21, 22 of each emitting antenna 20ₜ₁-20ₜ₈.

Following this excitation, the functional antenna parts 21, 22 of each emitting antenna 20ₜ₁-20ₜ₈ again emit an electromagnetic radiation in particular directed towards the surface 76 of the ground 75.

The functional antenna parts 21, 22 of each receiving antenna 20ᵣ₁-20ᵣ₈ capture an incident electromagnetic radiation corresponding to the electromagnetic radiation emitted by each emitting antenna 20ₜ₁-20ₜ₈.

A second radar diagram (shown in FIG. 6b) is then obtained, as well as a second impulse response of each of the receiving antennas 20ᵣ₁-20ᵣ₈. In particular, the impulse response of the receiving antenna 20ᵣ₄ is shown in dashed lines in FIG. 7. As can be seen in FIGS. 6a, 6b and 7, the radar 70 is, in the second radar operation mode (FIG. 6b, impulse response in dashed lines in FIG. 7) particularly effective in detecting and identifying the first pipe 81 whose wall returns a first echo received at approximately 4 nanoseconds (ns) and a second echo received at approximately 7 ns (the downwardly emitted electromagnetic radiation in effect passing twice through the wall of the first pipe 81).

Indeed, the direct coupling and the front surface echo (received between 0.7 and 2 ns) being particularly attenuated in the second radar operating mode, the two echoes produced by the wall of the first pipe 81 are perfectly distinguishable.

In the first radar operating mode (FIG. 6a, impulse response in solid lines in FIG. 7), the direct coupling and the front surface echo are more intense and the echoes produced by the walls of the first pipe 81 could go unnoticed.

However, the radar 70 is, in the first radar operating mode, more effective in detecting and identifying the second pipe 82 whose wall produces two echoes received respectively at approximately 14 and 17 ns (it should be noted that the echo received from 20 ns corresponds to the metal plate located under the ground 75.

It should be noted that the invention is not limited to the embodiment shown in the figures. In particular, the resistive elements 31, 32, 33, 34 could obviously and without departing from the scope of the present invention, be disposed differently, and have other electrical resistance values than those of the shown embodiment. The radar 70 could further operate in other radar operating modes in which, for example, some switching elements 28 could occupy the first position 28.1 of the switching element, while other switching elements 28 would occupy the second position 28.2 of the switching element.

Furthermore, the invention is not limited to Bowtie antennas and can be applied to other types of biconical antennas as well as other types of antennas such as dipole antennas, Vivaldi-type antennas, or even sinuous antennas, which can also integrate switchable resistive loads (that is to say which can be activated or deactivated depending on needs and applications).

As has just been demonstrated, the antenna of the invention can advantageously be used within a ground radar, but is not limited to this application. Such an antenna can in fact also be used within any imaging system based on microwaves, such as for example pulse radars adapted to the medical field or radars used in non-destructive detection, inspection and imaging techniques.

1. An antenna for a radar, the antenna comprising:
a functional antenna part comprising a conductive portion, and a resistive portion having a resistive portion electrical resistance, the functional antenna part being capable of occupying:
a first functional part electrical state in which the resistive portion has a first resistive portion electrical resistance value;
at least one second functional part electrical state in which the resistive portion has a second resistive portion electrical resistance value greater than said first resistive portion electrical resistance value;
a control mechanism capable of occupying:
a first control mechanism position causing the functional antenna part to occupy the first functional part electrical state;
at least one second control mechanism position causing the functional antenna part to occupy the at least one second functional part electrical state.

2. The antenna according to claim 1, wherein the conductive portion comprises a first conductive sub-portion, and a second conductive sub-portion electrically connected to the first conductive sub-portion.

3. The antenna according to claim 2, wherein the resistive portion comprises a first resistive element and a second resistive element, the control mechanism comprising a first switching element configured to:
occupy a first position of the first switching element in which the first switching element directs towards the first resistive element an electrical current flowing between the first conductive sub-portion and the second conductive sub-portion;
occupy a second position of the first switching element in which the first switching element directs towards the second resistive element said electrical current flowing between the first conductive sub-portion and the second conductive sub-portion.

4. The antenna according to claim 2, wherein the conductive portion comprises a third conductive sub-portion electrically connected to the second conductive sub-portion.

5. The antenna according to claim 4, wherein the resistive portion comprises a third resistive element and a fourth resistive element, the control mechanism comprising a second switching element configured to:
occupy a first position of the second switching element in which the second switching element directs towards the third resistive element an electrical current flowing between the second conductive sub-portion and the third conductive sub-portion;
occupy a second position of the second switching element in which the second switching element directs towards the fourth resistive element said electrical current flowing between the second conductive sub-portion and the third conductive sub-portion.

6. The antenna according to claim 1, comprising an antenna excitation part capable of transmitting an electrical current to the functional antenna part.

7. The antenna according to claim 6, wherein, when the antenna excitation part transmits an electrical current to the functional antenna part, the conductive portion is traversed by an electrical current and the functional antenna part is configured to emit an electromagnetic radiation.

8. The antenna according to claim 1, wherein the functional antenna part is configured to capture an incident electromagnetic radiation and to convert said incident electromagnetic radiation into an electrical current flowing through the conductive portion.

9. A radar comprising at least one antenna according to claim 1 and being capable of operating in:
a first radar operating mode in which the functional antenna part occupies the first functional part electrical state;
at least one second radar operating mode in which the functional antenna part occupies the at least one second functional part electrical state.

10. The radar according to claim 9, comprising at least one first antenna and one second antenna the radar being a ground radar.

11. A method of operating a radar according to claim 10, the method comprising:
a step of switching the control mechanism of the at least one first antenna to the first control mechanism position or to the at least one second control mechanism position;
a step, implemented by the antenna excitation part of the at least one first antenna, of exciting the functional antenna part of the at least one first antenna;
a step, implemented by the functional antenna part of the at least one first antenna, of emitting an electromagnetic radiation;
a step, implemented by the functional antenna part of the at least one second antenna, of detecting an incident electromagnetic radiation.
